(19) United States
(12) Patent Application Publication
(10) Pub. No.: US 2014/0200021 A1
(43) Pub. Date: Jul. 17, 2014

(54) Interference Processing Method and Device

(71) Applicant: Huawei Technologies Co., LTD, Shenzhen (CN)

(72) Inventors: Shurong Jiao, Shanghai (CN); Meng Hua, Shanghai (CN); Xiaolei Tie, Shanghai (CN)

(73) Assignee: Huawei Technologies Co., LTD, Shenzhen (CN)

(21) Appl. No.: 14/157,228

(22) Filed: Jan. 16, 2014

(30) Foreign Application Priority Data
Jan. 17, 2013 (CN) 201310017712.X

(51) Int. Cl. H04W 72/08

(52) U.S. Cl. CPC H04W 72/082
USPC 455/452.2

(57) ABSTRACT

Embodiments of the present invention provide an interference processing method and device. A user equipment receives a notification message sent by a network side. The notification message includes a resource scheduling manner of a first base station, and the resource scheduling manner is a manner of allocating, by the first base station, resources for downlink service data transmission of a local user equipment. The user equipment detects, according to the resource scheduling manner, an interference signal generated by the first base station and performs interference cancellation processing according to a detection result.

### CROSS-REFERENCE TO RELATED APPLICATIONS

This application claims priority to Chinese Patent Application No. 201310017712.X, filed on Jan. 17, 2013, which is hereby incorporated by reference in its entirety.

### TECHNICAL FIELD

Embodiments of the present invention relate to communications technologies, and in particular, to an interference processing method and device.

### BACKGROUND

In a heterogeneous network, a macro base station and a micro base station are used for hybrid networking. A cell managed by the macro base station is a macro cell, and a cell managed by the micro base station is a micro cell. Transmit power of the macro cell is higher than that of the micro cell. Therefore, usually the geographic coverage of the macro cell is wider than that of the micro cell.

In a network formed by the macro cell and the micro cell, a user equipment selects one cell to camp. A camping principle is as follows: The user equipment detects pilot signal-to-interference ratios of different cells; when finding that a pilot signal-to-interference ratio of a cell is higher than those of other cells, the user equipment may notify a network side by using radio resource control (RRC) signaling and select a cell with a high pilot signal-to-interference ratio to camp. In order for the micro cell to achieve wider coverage, the network side may set, when a difference between the pilot signal-to-interference ratio of the macro cell and the pilot signal-to-interference ratio of the micro cell is greater than or equal to a cell-specific offset, a serving cell of the user equipment to the micro cell. The manner of increasing the coverage of the micro cell is referred to as coverage extending, and the user equipment located in an area after the coverage of the micro cell is extended becomes a user equipment within the extended coverage of the micro cell.

In the case of intra-frequency deployment of the macro cell and the micro cell, in a place where the pilot signal-to-interference ratio of the micro cell is lower than the pilot signal-to-interference ratio of the macro cell, the micro cell receives strong interference from the macro cell. Consequently, a signal-to-noise ratio of a received signal of the user equipment within the extended coverage of the micro cell is too low, and communication performance is very poor or data communication cannot be performed.

### SUMMARY

Embodiments of the present invention provide an interference processing method and device to improve data communication performance of a user equipment.

In a first aspect, an embodiment of the present invention provides an interference processing method, including:

receiving, by a user equipment, a notification message sent by a network side, where the notification message includes a resource scheduling manner of a first base station, and the resource scheduling manner is a manner of allocating, by the first base station, resources for downlink service data transmission of a local user equipment; and

detecting, by the user equipment according to the resource scheduling manner, an interference signal generated by the first base station, and performing interference cancellation processing according to a detection result;

where a cell in which the user equipment is located uses a second base station as a serving base station, and the first base station is a serving base station of a neighboring cell of the user equipment.

With reference to the first aspect, in a first possible implementation of the first aspect, the receiving, by a user equipment, a notification message sent by a network side includes:

receiving, by the user equipment, a notification message sent by the first base station by using physical layer signaling or a system broadcast message; or

receiving, by the user equipment, a notification message sent by the second base station by using physical layer signaling or a system broadcast message; or

receiving, by the user equipment, a notification message sent by a radio network controller by using RRC signaling.

With reference to the first possible implementation of the first aspect, in a second possible implementation of the first aspect, the detecting, by the user equipment according to the resource scheduling manner, an interference signal generated by the first base station includes:

acquiring, by the user equipment, a modulation manner or code channel information or a combination thereof according to the resource scheduling manner; and

detecting, by the user equipment according to the modulation manner or the code channel information or the combination thereof, the interference signal generated by the first base station, and obtaining interference information of the interference signal.

With reference to the first aspect or either one of the first and second possible implementations of the first aspect, in a third possible implementation of the first aspect, the resource scheduling manner includes any piece of the following information or a combination thereof:

the modulation manner;

the code channel information;

a spreading factor; and

a resource allocation rule.

With reference to the third possible implementation of the first aspect, in a fourth possible implementation of the first aspect, in a transmission time interval (TTI), one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

With reference to the third possible implementation of the first aspect or the fourth possible implementation of the first aspect, in a fifth possible implementation of the first aspect, the detecting, according to the resource scheduling manner, an interference signal generated by the first base station includes:

if the user equipment determines, according to the resource scheduling manner, that multiple code channels are continuous, performing, by the user equipment, joint detection for the multiple continuous code channels.

With reference to the fifth possible implementation of the first aspect, in a sixth possible implementation of the first aspect, before the performing, by the user equipment, joint detection for the multiple continuous code channels, the method further includes:

determining, by the user equipment, that the multiple continuous code channels use a same modulation manner; and

the performing, by the user equipment, joint detection for the multiple continuous code channels includes:

performing, by the user equipment, joint detection of the modulation manner for the multiple continuous code channels that use the same modulation manner.

With reference to the fifth possible implementation of the first aspect, in a seventh possible implementation of the first aspect, before the performing, by the user equipment, joint detection for the multiple continuous code channels, the method further includes:

determining, by the user equipment, that the multiple continuous code channels use same code channel power; and

the performing, by the user equipment, joint detection for the multiple continuous code channels includes:

performing, by the user equipment, joint detection of the code channel power for the multiple continuous code channels that use the same code channel power.

In a second aspect, an embodiment of the present invention provides an interference processing method, including:

acquiring, by a network-side device, a resource scheduling manner of a first base station, where the resource scheduling manner is a manner of allocating, by the first base station, resources for downlink service data transmission of a local user equipment; and

sending, by the network-side device, a notification message including the resource scheduling manner to a user equipment in a second base station, so that the user equipment in the second base station detects, according to the resource scheduling manner, an interference signal generated by the first base station and performs interference cancellation processing according to a detection result;

where a cell in which the user equipment is located in the second base station uses the second base station as a serving base station, and the first base station is a serving base station of a neighboring cell of the user equipment in the second base station.

With reference to the second aspect, in a first possible implementation of the second aspect, the network-side device is the first base station, and the acquiring, by a network-side device, a resource scheduling manner of a first base station includes:

generating, by the first base station, the resource scheduling manner; or

receiving, by the first base station, a notification message that is sent by the radio network controller and includes the resource scheduling manner.

With reference to the first possible implementation of the second aspect, in a second possible implementation of the second aspect, the sending, by the network-side device, a notification message including the resource scheduling manner to a user equipment in a second base station includes:

sending, by the first base station, the notification message including the resource scheduling manner to the user equipment in the second base station by using physical layer signaling or a system broadcast message.

With reference to the second aspect, in a third possible implementation of the second aspect, the network-side device is a radio network controller, and the acquiring, by a network-side device, a resource scheduling manner of a first base station includes:

generating, by the radio network controller, the resource scheduling manner; or

receiving, by the radio network controller, a notification message that is sent by the first base station and includes the resource scheduling manner.

With reference to the third possible implementation of the second aspect, in a fourth possible implementation of the second aspect, the sending, by the network-side device, a notification message including the resource scheduling manner to a user equipment in a second base station includes:

sending, by the radio network controller, the notification message including the resource scheduling manner to the user equipment in the second base station by using RRC signaling.

With reference to the third possible implementation of the second aspect, in a fifth possible implementation of the second aspect, the network-side device is the second base station, and the acquiring, by a network-side device, a resource scheduling manner of a first base station includes:

receiving, by the second base station, a notification message that is sent by the radio network controller and includes the resource scheduling manner.

With reference to the fifth possible implementation of the second aspect, in a sixth possible implementation of the second aspect, the sending, by the network-side device, a notification message including the resource scheduling manner to a user equipment in a second base station includes:

sending, by the second base station, the notification message including the resource scheduling manner to the user equipment in the second base station by using physical layer signaling or a system broadcast message.

With reference to the second aspect or any one of the first to sixth possible implementations of the second aspect, in a seventh possible implementation of the second aspect, the resource scheduling manner includes any piece of the following information or a combination thereof:

a modulation manner;

code channel information;

a spreading factor; and

a resource allocation rule.

With reference to the seventh possible implementation of the second aspect, in an eighth possible implementation of the second aspect, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

In a third aspect, an embodiment of the present invention provides a user equipment, including:

a receiving module, configured to receive a notification message sent by a network side, where the notification message includes a resource scheduling manner of a first base station, and the resource scheduling manner is a manner of allocating, by the first base station, resources for downlink service data transmission of a local user equipment; and

a processing module, configured to detect, according to the resource scheduling manner, an interference signal generated by the first base station, and perform interference cancellation processing according to a detection result;

where a cell in which the user equipment is located uses a second base station as a serving base station, and the first base station is a serving base station of a neighboring cell of the user equipment.

With reference to the third aspect, in a first possible implementation of the third aspect, the receiving module is specifically configured to:

receive a notification message sent by the first base station by using physical layer signaling or a system broadcast message; or

receive a notification message sent by the second base station by using physical layer signaling or a system broadcast message; or

receive a notification message sent by a radio network controller by using RRC signaling.

With reference to the first possible implementation of the third aspect, in a second possible implementation of the third aspect, the processing module is specifically configured to:

acquire a modulation manner or code channel information or a combination thereof according to the resource scheduling manner; and

detect, according to the modulation manner or the code channel information or the combination thereof, the interference signal generated by the first base station, and obtain interference information of the interference signal.

With reference to the third aspect or either one of the first and second possible implementations of the third aspect, in a third possible implementation of the third aspect, the resource scheduling manner includes any piece of the following information or a combination thereof:

the modulation manner;

the code channel information;

a spreading factor; and

a resource allocation rule.

With reference to the third possible implementation of the third aspect, in a fourth possible implementation of the third aspect, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

With reference to the third possible implementation of the third aspect or the fourth possible implementation of the third aspect, in a fifth possible implementation of the third aspect, the processing module is specifically configured to:

determine, according to the resource scheduling manner, that multiple code channels are continuous, and then perform joint detection for the multiple continuous code channels.

With reference to the fifth possible implementation of the third aspect, in a sixth possible implementation of the third aspect, the processing module is further configured to:

determine that the multiple continuous code channels use a same modulation manner; and

the processing module is further specifically configured to:

perform joint detection of the modulation manner for the multiple continuous code channels that use the same modulation manner.

With reference to the fifth possible implementation of the third aspect, in a seventh possible implementation of the third aspect, the processing module is further configured to:

determine that the multiple continuous code channels use same code channel power; and

the processing module is further specifically configured to:

perform joint detection of the code channel power for the multiple continuous code channels that use the same code channel power.

In a fourth aspect, an embodiment of the present invention provides a network-side device, including:

an acquiring module, configured to acquire a resource scheduling manner of a first base station, where the resource scheduling manner is a manner of allocating, by the first base station, resources for downlink service data transmission of a local user equipment; and

a sending module, configured to send a notification message including the resource scheduling manner to a user equipment in a second base station, so that the user equipment in the second base station detects, according to the resource scheduling manner, an interference signal generated by the first base station and performs interference cancellation processing according to a detection result;

where a cell in which the user equipment is located in the second base station uses the second base station as a serving base station, and the first base station is a serving base station of a neighboring cell of the user equipment in the second base station.

With reference to the fourth aspect, in a first possible implementation of the fourth aspect, the network-side device is the first base station, and the acquiring module is specifically configured to:

generate the resource scheduling manner; or

receive a notification message that is sent by a radio network controller and includes the resource scheduling manner.

With reference to the first possible implementation of the fourth aspect, in a second possible implementation of the fourth aspect, the sending module is specifically configured to:

send the notification message including the resource scheduling manner to the user equipment in the second base station by using physical layer signaling or a system broadcast message.

With reference to the fourth aspect, in a third possible implementation of the fourth aspect, the network-side device is a radio network controller, and the acquiring module is specifically configured to:

generate the resource scheduling manner; or

receive a notification message that is sent by the first base station and includes the resource scheduling manner.

With reference to the third possible implementation of the fourth aspect, in a fourth possible implementation of the fourth aspect, the sending module is specifically configured to:

send the notification message including the resource scheduling manner to the user equipment in the second base station by using RRC signaling.

With reference to the third possible implementation of the fourth aspect, in a fifth possible implementation of the fourth aspect, the network-side device is the second base station, and the acquiring module is specifically configured to:

receive a notification message that is sent by the radio network controller and includes the resource scheduling manner.

With reference to the fifth possible implementation of the fourth aspect, in a sixth possible implementation of the fourth aspect, the sending module is specifically configured to:

send the notification message including the resource scheduling manner to the user equipment in the second base station by using physical layer signaling or a system broadcast message.

With reference to the fourth aspect or any one of the first to sixth possible implementations of the fourth aspect, in a seventh possible implementation of the fourth aspect, the resource scheduling manner includes any piece of the following information or a combination thereof:

a modulation manner;

code channel information;

a spreading factor; and

a resource allocation rule.

With reference to the seventh possible implementation of the fourth aspect, in an eighth possible implementation of the fourth aspect, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

According to the interference processing method and device provided by the embodiments of the present invention, a user equipment in a second base station receives a notification message sent by a network side, where the notification message includes a resource scheduling manner of a first base station, and the resource scheduling manner is a manner of allocating, by the first base station, resources for downlink service data transmission of a local user equipment; and the user equipment in the second base station detects, according to the resource scheduling manner, an interference signal generated by the first base station, and performs interference cancellation processing according to a detection result, where the user equipment in the second base station detects and cancels interference only in a limited resource set. In this way, the speed and precision of detection and interference cancellation are improved, thereby improving data communication performance of the user equipment in the second base station.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flowchart of a first embodiment of an interference processing method according to the present invention;

FIG. 2 is a flowchart of a second embodiment of an interference processing method according to the present invention;

FIG. 3 is a schematic structural diagram of a first embodiment of a user equipment according to the present invention;

FIG. 4 is a schematic structural diagram of a first embodiment of a network-side device according to the present invention;

FIG. 5 is a schematic structural diagram of a second embodiment of a user equipment according to the present invention; and

FIG. 6 is a schematic structural diagram of a second embodiment of a network-side device according to the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

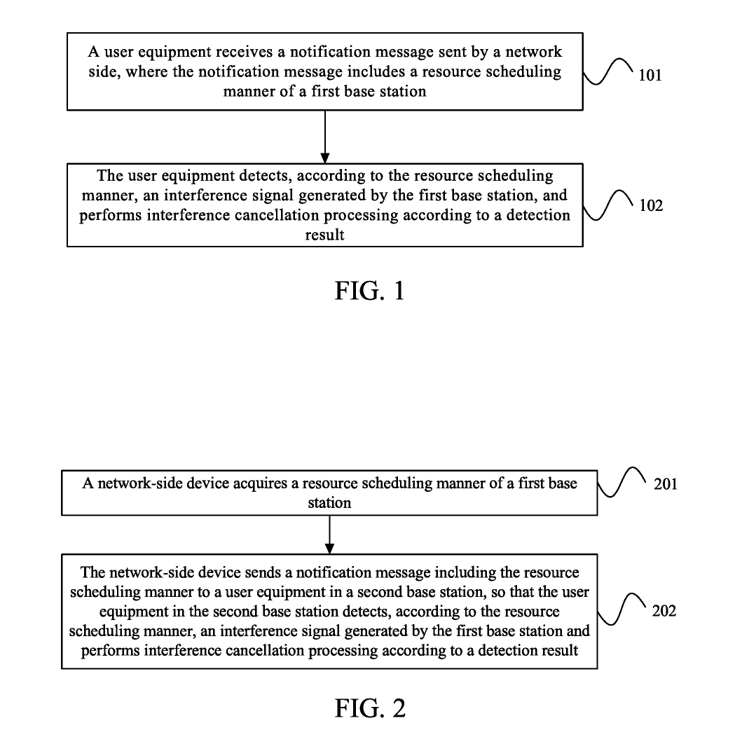

FIG. 1 is a flowchart of a first embodiment of an interference processing method according to the present invention. This embodiment provides an interference processing method, where the method may be executed by any user equipment that executes the interference processing method. The user equipment may be implemented by software and/or hardware, and the user equipment may be specifically various terminals having a communication function. As shown in FIG. 1, the method in this embodiment may include:

Step 101: A user equipment receives a notification message sent by a network side, where the notification message includes a resource scheduling manner of a first base station.

Step 102: The user equipment detects, according to the resource scheduling manner, an interference signal generated by the first base station, and performs interference cancellation processing according to a detection result.

The resource scheduling manner is a manner of allocating, by the first base station, resources for downlink service data transmission of a local user equipment; a cell in which the user equipment is located uses a second base station as a serving base station, and the first base station is a serving base station of a neighboring cell of the user equipment.

In an application scenario of this embodiment, a first base station and a second base station using a same frequency are included, where the first base station is a serving base station of a neighboring cell of the user equipment, and the second base station is a serving base station of the current cell of the user equipment. Particularly, the first base station and the second base station may further form a heterogeneous network, where the first base station is used as a macro base station and the second base station is used as a micro base station. When the first base station transmits downlink data, interference is caused to the user equipment in the second base station. Therefore, the user equipment in the second base station needs to cancel the interference caused by the first base station to improve communication performance of the user equipment. Step 101 and step 102 describe in detail how the user equipment in the second base station performs cancellation processing for the interference caused by the first base station.

In step 101, the user equipment in the second base station receives the notification message sent by the network side; in a specific implementation process, there are the following three possible implementations:

In one possible implementation, the user equipment in the second base station receives, in a monitoring manner, a notification message sent by the first base station by using physical layer signaling or a system broadcast message. The physical layer signaling may specifically be high speed shared control channel (HS-SCCH) signaling.

In another possible implementation, the user equipment in the second base station receives a notification message sent by the second base station by using physical layer signaling or a system broadcast message. The physical layer signaling may specifically be HS-SCCH signaling.

In still another possible implementation, the user equipment in the second base station receives a notification message sent by a radio network controller (RNC) by using RRC signaling.

In this embodiment of the present invention, any possible implementation may be selected from the three possible implementations according to actual requirements and configurations of various network-side devices, so that the user equipment in the second base station receives the notification message sent by the network side. There are multiple manners for the user equipment in the second base station to receive the notification message sent by the network side, thereby ensuring that the user equipment in the second base station can obtain, in a timely and accurate manner, a notification message including resource scheduling manner information.

In the three possible implementations, a resource scheduling manner is included in the notification message. Particularly, the resource scheduling manner may include any one or a combination of the following:

a modulation manner; code channel information; a spreading factor; and a resource allocation rule.

The modulation manner may specifically be the number and types of modulation manners used when a user equipment in the first base station performs data modulation. The number of modulation manners restricts the modulation manners of the user equipment, and restricts use of one or two modulation manners for a downlink service sent to the user equipment. The types of modulation manners may be quadrature phase shift keying (QPSK), 16-symbol quadrature amplitude modulation (16QAM), 64-symbol Quadrature Amplitude Modulation (64QAM), and so on.

The code channel information may specifically be the number of code channels required for downlink service transmission and allocated by the first base station to the user equipment in the first base station, positions of code channels, and code channel power. The code channel power may specifically be downlink service transmit power; when the amount of data in downlink service transmission is relatively large, the code channel power is relatively high; when the amount of data in downlink service transmission is relatively small, the code channel power is relatively low.

The spreading factor is a ratio of signal bandwidth after spread spectrum modulation to signal bandwidth before spread spectrum modulation, and the spreading factor corresponds to the number of code channels. For example, if the spreading factor is 16, the total number of code channels may specifically be 16.

The resource allocation rule is a rule of allocating, by the first base station, a code channel to the user equipment in the first base station according to a specific modulation manner and code channel power.

In step 102, the user equipment in the second base station detects, according to the resource scheduling manner, an interference signal generated by the first base station, and performs interference cancellation processing according to a detection result.

In the specific implementation process, when the resource scheduling manner includes only the code channel power, the user equipment in the second base station detects whether power exists in each code channel; after detecting power, detects a modulation manner on a code channel having power, finally determines the number of code channels, modulation manner, and code channel power, and performs, according to the number of code channels, modulation manner, and code channel power by using the prior art, interference cancellation processing for the interference caused by the first base station due to the downlink service transmission.

Those skilled in the art may understand that when the resource scheduling information includes the modulation manner or the number of code channels or the code channel power or the spreading factor or the resource allocation rule or a combination thereof, other information may be determined according to known information in the resource scheduling manner; a manner of determining other information is similar to the determining manner when the resource scheduling information includes only the code channel power, and are not further described in this embodiment.

Those skilled in the art may understand that the user equipment in the second base station in this embodiment detects an interference signal format in the first base station according to only the resource scheduling manner, that is, in a limited resource set, and performs interference cancellation according to a detection result, without detecting the interference signal format in all unlimited sets, which narrows the detection scope greatly.

According to the interference processing method provided by this embodiment of the present invention, a user equipment in a second base station receives a notification message sent by a network side, where the notification message includes a resource scheduling manner of a first base station, the resource scheduling manner is a manner of allocating, by the first base station, resources for downlink service data transmission of a local user equipment; and the user equipment in the second base station detects, according to the resource scheduling manner, an interference signal generated by the first base station, and performs interference cancellation processing according to a detection result, where the user equipment in the second base station detects and cancels interference only in a limited resource set. In this way, the speed and precision of detection and interference cancellation are improved, thereby improving data communication performance of the user equipment in the second base station.

FIG. 2 is a flowchart of a second embodiment of an interference processing method according to the present invention. This embodiment provides an interference processing method, where the method may be executed by any network-side device that executes the interference processing method. The network-side device may be implemented by software and/or hardware, and the network-side device may specifically be a network device having a communication function, such as a base station and a radio network controller. As shown in FIG. 2, the method in this embodiment may include:

Step 201: A network-side device acquires a resource scheduling manner of a first base station.

Step 202: The network-side device sends a notification message including the resource scheduling manner to a user equipment in a second base station, so that the user equipment in the second base station detects, according to the resource scheduling manner, an interference signal generated by the first base station and performs interference cancellation processing according to a detection result.

The resource scheduling manner is a manner of allocating, by the first base station, resources for downlink service data transmission of a local user equipment; a cell in which the user equipment is located in the second base station uses the second base station as a serving base station, and the first base station is a serving base station of a neighboring cell of the user equipment in the second base station.

In this embodiment, an application scenario of the interference processing method and the meanings of the first base station and second base station are similar to those in the embodiment shown in FIG. 1, and are not further described herein.

In step 201, the acquiring, by the network-side device, the resource scheduling manner of the first base station varies according to the network-side device; the following uses several specific embodiments to describe in detail the acquiring, by the network-side device, the resource scheduling manner of the first base station.

In a possible implementation, the network-side device is the first base station; and the acquiring, by the network-side device, the resource scheduling manner of the first base station includes:

generating, by the first base station, the resource scheduling manner; or

receiving, by the first base station, a notification message that is sent by a radio network controller and includes the resource scheduling manner.

In a specific implementation process, there are three acquiring manners for the first base station. One manner is that the first base station may generate the resource scheduling manner according to the amount of data in downlink service transmission of the user equipment, network performance of a cell served by the first base station, interference caused by the first base station to the user equipment in the second base station, and so on. Another manner is that the first base station may receive a notification message sent by the radio network controller, where the notification message includes the resource scheduling manner of the first base station. Meanwhile, the resource scheduling manner may include the number of modulation manners or may further include types of modulation manners. Still another manner is that the first base station receives a notification message sent by the radio network controller, where the notification message includes only a resource allocation rule of the first base station, and the first base station further determines specific scheduling information, where the specific scheduling information may include: a modulation manner; code channel information; and a spreading factor.

In another possible implementation, the network-side device is the radio network controller; and the acquiring, by the network-side device, the resource scheduling manner of the first base station includes:

generating, by the radio network controller, the resource scheduling manner; or

receiving, by the radio network controller, a notification message that is sent by the first base station and includes the resource scheduling manner.

In a specific implementation process, there are three acquiring manners for the radio network controller: One manner is that the radio network controller may generate the resource scheduling manner according to the amount of data in downlink service transmission of a user equipment in the first base station, network performance of a cell served by the first base station, interference caused by the first base station to the user equipment in the second base station, and so on. Another manner is that the radio network controller receives a notification message sent by the first base station, where the notification message includes the resource scheduling manner of the first base station. Still another manner is that the radio network controller generates a resource allocation rule of the first base station and notifies the rule to the first base station, and then receives specific scheduling information further determined by the first base station, where the specific scheduling information may include: a modulation manner; code channel information; and a spreading factor.

In still another possible implementation, the network-side device is the second base station; and the acquiring, by the network-side device, the resource scheduling manner of the first base station includes:

receiving, by the second base station, a notification message that is sent by the radio network controller and includes the resource scheduling manner.

In a specific implementation process, after the radio network controller acquires the resource scheduling manner of the first base station, the radio network controller sends a notification message to the second base station; the second base station receives the notification message sent by the radio network controller, where the notification message includes resource scheduling restriction information.

In this embodiment of the present invention, any possible implementation may be selected from the three possible implementations according to actual requirements and configurations of various network-side devices, so that the user equipment in the second base station receives the notification message sent by the network side. There are multiple manners for the user equipment in the second base station to receive the notification message sent by the network side, thereby ensuring that the user equipment in the second base station can obtain, in a timely and accurate manner, a notification message including resource scheduling manner information.

In the three possible implementations, the resource scheduling manner includes any piece of the following information or a combination thereof: a modulation manner; code channel information; a spreading factor; and a resource allocation rule.

In step 202, after acquiring the resource scheduling manner of the first base station, the network-side device, such as the first base station, the radio network controller, and the second base station, sends a notification message including the resource scheduling manner to the user equipment in the second base station, so that the user equipment in the second base station detects, according to the resource scheduling manner, the interference signal generated by the first base station and performs interference cancellation processing according to the detection result.

The first base station and the second base station may send a notification message including the resource scheduling manner to the user equipment in the second base station by using HS-SCCH signaling or a system broadcast message; the radio network controller sends a notification message including the resource scheduling manner to the user equipment in the second base station by using RRC signaling.

According to the interference processing method provided by this embodiment of the present invention, a network-side device acquires a resource scheduling manner of a first base station; the network-side device sends a notification message including the resource scheduling manner to a user equipment in a second base station. The user equipment in the second base station detects and cancels interference only in a limited resource set. In this way, the speed and precision of detection and interference cancellation are improved, thereby improving data communication performance of the user equipment in the second base station.

In the embodiments shown in FIG. 1 and FIG. 2, a code channel resource allocation rule restricts resources for downlink service transmission of some user equipments in the first base station on the basis of ensuring normal communication of most user equipments in the first base station, thereby reducing interference caused to the user equipment in the second base station. Particularly, the resource allocation rule varies according to the downlink service. In this embodiment, the downlink service may specifically include a high speed downlink packet access service and an R99 service of a Wideband Code Division Multiple Access (WCDMA) communication protocol. The R99 service and the high speed downlink packet access service are distinguished based on physical channels; a downlink R99 service is carried by a downlink dedicated physical channel (DPCH), while the high speed downlink packet access service is carried by a high speed downlink shared channel (HS-DSCH).

The following describes the resource allocation rule in detail according to different downlink services. Those skilled in the art may understand that in the description of the resource allocation rule, resources are allocated to a user equipment, and the user equipment is the user equipment in the first base station.

When the downlink service is a high speed downlink packet access service, the logical channel HS-DSCH at a transport layer is used to transmit downlink data to be sent to the user equipment; the HS-DSCH is mapped to a high speed physical downlink shared channel (HS-PDSCH) at the physical layer; a spreading factor of a channel code used by each HS-PDSCH is fixed to 16, that is, the HS-PDSCH may be divided into 16 parallel transmission code channels for downlink data, and preset sequence numbers of corresponding code channels are 0 to 15. Code channels that can be used in the high speed downlink packet access service are 1 to N, where N is an integer and N is smaller than or equal to 15. A HS-SCCH at the physical layer is used to carry scheduling and downlink control information of the HS-DSCH. For a TTI of each HS-DSCH, downlink control information of the scheduled user equipment in the first base station, which is carried by the HS-SCCH, includes code channel information, a modulation manner, a data block size index, a process number, a retransmission version information, and so on.

In this embodiment, the resource allocation rule includes the following possible implementations:

In one possible implementation, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence.

For example, in a TTI, modulation manners are restricted and one modulation manner is restricted to be available; when the user equipment in the first base station uses the restricted modulation manner, a code channel is sequentially allocated to the at least one user equipment in the first base station based on the first preset sequence. The first preset sequence may be sequentially allocating a code channel to the at least one user equipment in the first base station in an ascending manner from the minimum value of the preset sequence value, may also be sequentially allocating a code channel to the at least one user equipment in the first base station in a descending manner from the maximum value of the preset sequence value, and may also be allocating a code channel to a user equipment in an ascending or descending manner from the middle value of the preset sequence value.

In this embodiment, herein a code channel is sequentially allocated to the at least one user equipment in the first base station in an ascending manner from the minimum value of the preset sequence value, for example, starting from code channel 1, code channels 1 to a are allocated to user equipment 1, and code channels a+1 to b are allocated to user equipment 2, where a+1<b<N, and so on.

In another possible implementation, the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence.

For example, in a TTI, modulation manners are restricted and two modulation manners are restricted to be available; when user equipments in the first base station use the restricted modulation manners, code channels are allocated to the user equipments according to the orders of the restricted manners and the preset sequence values and based on a second preset sequence. Orders of common modulation manners, from low to high, are QPSK, 16QAM, and 64QAM. In this embodiment, the second preset sequence may be sequentially allocating a code channel to a user equipment of a high order modulation manner in the first base station in a descending manner from the maximum value of the preset sequence value, and the third preset sequence may be sequentially allocating a code channel to a user equipment of a low order modulation manner in the first base station in an ascending manner from the minimum value of the preset sequence value. The second preset sequence may also be sequentially allocating a code channel to a user equipment of a low order modulation manner in the first base station in a descending manner from the maximum value of the preset sequence value, and the third preset sequence may be sequentially allocating a code channel to a user equipment of a high order modulation manner in the first base station in an ascending manner from the minimum value of the preset sequence value.

Using an implementation as an example, a code channel is allocated to a user equipment of a low order modulation manner in an ascending manner from code channel 1, and a code channel is allocated to a user equipment of a high order modulation manner in a descending manner from code channel N. For example, if user equipment 1 and user equipment 2 use QPSK modulation, and user equipment 3 uses 16QAM modulation, code channels 1 to a are allocated to user equipment 1, code channels a+1 to b are allocated to user equipment 2, and code channels c to N are allocated to user equipment 3, where b<c.

Those skilled in the art may understand that in the two implementations, only the restriction on the modulation manner is considered without considering the value of code channel power. The specific restriction on the modulation manner is shown in table 1. In a specific implementation process, the restriction on the modulation manner may be determined according to table 1.

TABLE 1

| Restricted Type | Modulation Manner |
|---|---|
| 1 | QPSK |
| 2 | 16QAM |
| 3 | 64QAM |
| 4 | QPSK + 16QAM |
| 5 | QPSK + 64QAM |
| 6 | 16QAM + 64QAM |

In still another possible implementation, the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, where the first code channel power is higher than the second code channel power.

In this embodiment of the present invention, code channel power needs to be considered when the modulation manners are restricted and one modulation manner is restricted to be available. The fourth preset sequence may be sequentially allocating a code channel to a user equipment meeting the first code channel power in the first base station in a descending manner from the maximum value of the preset sequence value, and the fifth preset sequence may be sequentially allocating a code channel to a user equipment meeting the second code channel power in the first base station in an ascending manner from the minimum value of the preset sequence value. The fourth preset sequence may also be sequentially allocating a code channel to a user equipment meeting the first code channel power in the first base station in an ascending manner from the minimum value of the preset sequence value, and the fifth preset sequence may be sequentially allocating a code channel to a user equipment meeting the second code channel power in the first base station in a descending manner from the maximum value of the preset sequence value, where the first code channel power is higher than the second code channel power.

Using an implementation as an example, if there are two user equipments in a TTI, where a user equipment 1 meets the first code channel power, and user equipment 2 meets the second code channel power, a code channel is allocated to user equipment 1 in an ascending manner from code channel 1, and a code channel is allocated to user equipment 2 in a descending manner from code channel N. If there are three user equipments in a TTI, first the user equipments are marked as user equipment 1, user equipment 2, and user equipment 3 in an ascending manner according to single code channel power. User equipment 1 and user equipment 2 meet the first code channel power, and user equipment 3 meets the second preset power; therefore, code channels are allocated to user equipment 1 and user equipment 2 in an ascending manner from code channel 1, and a code channel is allocated to user equipment 3 in a descending manner from code channel N. If there are four user equipments in a TTI, first the user equipments are marked as user equipment 1, user equipment 2, user equipment 3, and user equipment 4 in an ascending manner according to single code channel power. User equipment 1 and user equipment 2 meet the first code channel power, and user equipment 3 and user equipment 4 meet the second code channel power; therefore code channels are allocated to user equipment 1 and user equipment 2 in an ascending manner from code channel 1, and code channels are allocated to user equipment 3 and user equipment 4 in a descending manner from code channel N, and so on, which is not further described in this embodiment.

When the downlink service is an R99 service, the DPCH includes a dedicated physical control channel (DPCCH) and a dedicated physical data channel (DPDCH). The DPCCH is used to carry scheduling information of the DPCH, including known pilot bits supporting channel estimation to perform coherence detection, a transmit power control command, feedback information, an optional transmission format combination indication, and so on; the DPDCH is a channel for carrying a basic service at the physical layer. The spreading factor of the DPDCH changes in the range of 256 to 4.

In this embodiment, the resource allocation rule includes the following possible implementations:

In a possible implementation, the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence.

In a specific implementation process, the R99 service can use only QPSK modulation. When the user equipment in the first base station uses the QPSK modulation manner, the first base station sequentially allocates a code channel among the first preset code channels to at least one user equipment in the first base station according to the first spreading factor and based on the sixth preset sequence. Those skilled in the art may understand that the spreading factor of the DPDCH used by the R99 service changes in the range of 256 to 4, and therefore, the first spreading factor may be set to any spreading factor in the range of 256 to 4 according to actual requirements. For example, when the first spreading factor is 128, M code channels with fixed code channel numbers may be selected from code channels corresponding to the spreading factor 128 and used as the first preset code channels allocated to the user equipment. M is an integer greater than 0. The sixth preset sequence may be allocating a code channel to a user equipment in an ascending or descending manner based on preset sequence values of the M code channels.

In another possible implementation, the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

In this implementation, a restricted code channel is allocated to only the interfering user equipment. Specifically, when the user equipment in the first base station uses the modulation manner restricted by QPSK, the first base station may determine, according to the status parameter of the user equipment, that the user equipment is an interfering user equipment. The status parameter of the user equipment may include: an initial value of open-loop power of the downlink DPCCH and downlink service power of the user equipment, or a location of the user equipment at an edge of the first base station, or a location of the user equipment in a soft handover area between the first base station and the second base station, and so on. The interfering user equipment means that the user equipment causes relatively great interference to the user equipment in the second base station.

When it is determined that the user equipment is an interfering user equipment, the first base station sequentially allocates a code channel among the second preset code channels to the at least one user equipment in the first base station according to the second preset spreading factor and based on the seventh preset sequence. The second spreading factor may be set to any spreading factor in the range of 256 to 4 according to actual requirements. For example, when the second spreading factor is 64, N code channels with fixed code channel numbers may be selected from code channels corresponding to the spreading factor 64 and used as the second preset code channels allocated to the user equipment. N is an integer greater than 0. The seventh preset sequence may be allocating a code channel to a user equipment in an ascending or descending manner based on preset sequence values of the N code channels.

Those skilled in the art may understand that in this embodiment, code channel resources of only a user equipment, which can cause interference to the user equipment in the second base station, in the first base station are restricted, but code channel resources of other user equipments in the first base station are not restricted because little interference is caused to the user equipment in the second base station when the first base station schedules those user equipments.

In the interference processing method provided by this embodiment of the present invention, a code channel is allocated to a user equipment according to different downlink services and according to a code channel resource allocation principle. This restricts resources for downlink service transmission of some user equipments in a first base station on the basis of ensuring normal communication of most user equipments in the first base station, thereby reducing interference caused to a user equipment in a second base station.

On the basis of the embodiment shown in FIG. 1, the user equipment in the second base station detects, according to the resource scheduling manner, an interference signal generated by the first base station, which may specifically include the following two possible implementations. Those skilled in the art may understand that the executor that detects the interference signal generated by the first base station is a user equipment in the second base station.

In one possible implementation, the user equipment in the second base station acquires a modulation manner, code channel information, code channel power, or a combination thereof according to the resource scheduling manner; and detects, according to the modulation manner, the code channel information, the code channel power, or the combination thereof, the interference signal generated by the first base station, and obtains interference information of the interference signal.

For example, the user equipment in the second base station receives a notification message sent by the network side, where the notification message includes a resource scheduling manner, and the resource scheduling manner is specifically as follows: the modulation manner is QPSK or 16QAM, and the number of code channels is 5 or 10; in this case, there are four combinations of manners of detection performed by the user equipment in the second base station: QPSK+5 code channels, QPSK+10 code channels, 16QAM+5 code channels, or 16QAM+10 code channels. The user equipment in the second base station needs to perform detection in the four combinations.

Alternatively, the resource scheduling manner is specifically QPSK+10 code channels and 16QAM+5 code channels; in this case, the user equipment in the second base station only needs to perform detection in the two combinations. In addition, the user equipment in the second base station may select, according to its capability, whether to detect the modulation manner or the number of code channels, because the other piece of information can be inferred if one piece of information is detected.

Alternatively, the resource scheduling manner includes a modulation manner, code channel information, or a combination thereof; the user equipment in the second base station may select, according to its capability, whether to detect the modulation manner, the number of code channels, or the code channel power, because if one piece of information is detected, other information can be obtained according to the information.

In the implementation provided by this embodiment of the present invention, the user equipment in the second base station only needs to perform detection according to the resource scheduling manner, and detect the interference caused by the first base station in limited resource scheduling manners; therefore the interference detection is accurate and the efficiency is high.

In another possible implementation, the user equipment in the second base station performs joint detection for code channels. Specifically, it may be that if the user equipment determines, according to the resource scheduling manner, that multiple code channels are continuous, the user equipment performs joint detection for the multiple continuous code channels.

The user equipment in the second base station determines, according to the code channel information or resource allocation rule in the resource scheduling manner, that code channels allocated by the first base station to the user equipment in the first base station are continuous, for example, code channels allocated by the first base station to one user equipment in the first base station are continuous, and then the user equipment in the second base station detects existence of continuous code channels and directly excludes an error result indicating that the code channels are discontinuous. For another example, the user equipment in the second base station knows that code channels allocated by the first base station to one user equipment in the first base station are A continuous code channels, and then the user equipment in the second base station detects existence of A continuous code channels in different positions, and directly excludes an error result indicating that the code channels are discontinuous and an error result indicating that the number of code channels is not A. A is an integer greater than 0. Those skilled in the art may understand that in the continuous code channels, modulation manners may be different, and code channel power may also be different.

Particularly, before the user equipment in the second base station performs joint detection for multiple continuous code channels, the user equipment in the second base station may further determine the possibility that multiple code channels are continuous, which may specifically include two possible implementations:

One possible implementation is as follows: the user equipment in the second base station determines that multiple continuous code channels use a same modulation manner, and performs joint detection of the modulation manner for the multiple continuous code channels that use the same modulation manner.

In a specific implementation process, the user equipment in the second base station determines, according to the modulation manner, code channel information, or resource allocation rule in the resource scheduling manner, that code channels of the user equipment in the first base station are not only continuous but also use the same modulation manner, and then the user equipment in the second base station performs joint detection of the modulation manner for the multiple continuous code channels that use the same modulation manner.

Another possible implementation is as follows: the user equipment in the second base station determines that multiple continuous code channels use same code channel power, and performs joint detection of the code channel power for the multiple continuous code channels that use the same code channel power.

In a specific implementation process, the user equipment in the second base station determines, according to the code channel information or resource allocation rule in the resource scheduling manner, that code channels of the user equipment in the first base station are not only continuous but also use the same code channel power, and then the user equipment in the second base station performs joint detection of the code channel power for the multiple continuous code channels that use the same code channel power.

In the implementation of this embodiment, the user equipment in the second base station can perform, in a joint detection manner, joint detection for the interference generated by the first base station, and the obtained joint detection result may be a modulation manner used for downlink service transmission for the local user equipment in the first base station, or a scheduling manner such as the number of code channels, positions of code channels, or code channel power. The user equipment in the second base station reconstructs an interference signal according to the detection result, and subtracts the interference signal from received signals, that is, performs cancellation processing for the interference signal, thereby improving communication performance.

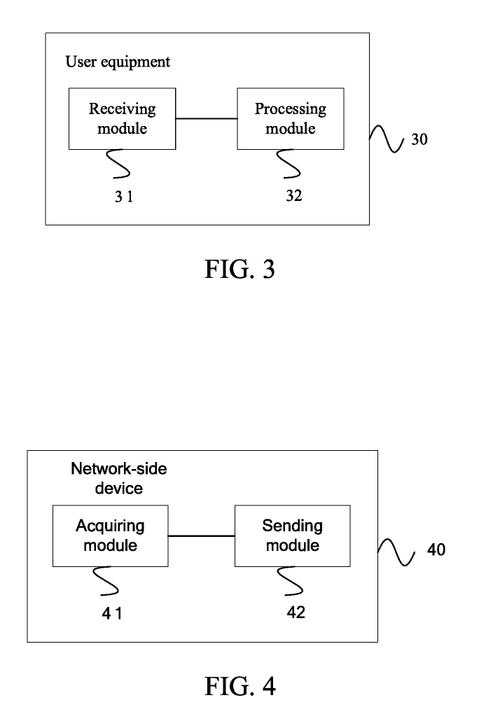

FIG. 3 is a schematic structural diagram of a first embodiment of a user equipment according to the present invention, where the user equipment provided by this embodiment may be various terminals having a communication function. As shown in FIG. 3, the user equipment 30 in this embodiment may include: a receiving module 31 and a processing module 32.

The receiving module 31 is configured to receive a notification message sent by a network side, where the notification message includes a resource scheduling manner of a first base station, and the resource scheduling manner is a manner of allocating, by the first base station, resources for downlink service data transmission of a local user equipment; and

the processing module 32 is configured to detect, according to the resource scheduling manner, an interference signal generated by the first base station, and perform interference cancellation processing according to a detection result;

where a cell in which the user equipment is located uses a second base station as a serving base station, and the first base station is a serving base station of a neighboring cell of the user equipment.

The user equipment in this embodiment may be used to execute the technical solution of the method embodiment shown in FIG. 1. The implementation principles and technical effects are similar, and are not further described herein.

Optionally, the receiving module 31 is specifically configured to:

receive a notification message sent by the first base station by using physical layer signaling or a system broadcast message; or

receive a notification message sent by the second base station by using physical layer signaling or a system broadcast message; or

receive a notification message sent by a radio network controller by using RRC signaling.

Optionally, the processing module 32 is specifically configured to:

acquire a modulation manner or code channel information or a combination thereof according to the resource scheduling manner; and

detect, according to the modulation manner or the code channel information or the combination thereof, the interference signal generated by the first base station, and obtain interference information of the interference signal.

Optionally, the resource scheduling manner includes any piece of the following information or a combination thereof:

the modulation manner;

the code channel information;

a spreading factor; and

a resource allocation rule.

Optionally, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, where the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

Optionally, the processing module 32 is specifically configured to:

determine, according to the resource scheduling manner, that multiple code channels are continuous, and then perform joint detection for the multiple continuous code channels.

Optionally, the processing module 32 is further configured to:

determine that the multiple continuous code channels use a same modulation manner; and

the processing module is further specifically configured to:

perform joint detection of the modulation manner for the multiple continuous code channels that use the same modulation manner.

Optionally, the processing module 32 is further configured to:

determine that the multiple continuous code channels use same code channel power; and

the processing module is further specifically configured to:

perform joint detection of the code channel power for the multiple continuous code channels that use the same code channel power.

The user equipment in this embodiment may be used to execute the technical solution of the foregoing method embodiment. The implementation principles and technical effects are similar, and are not further described herein.

FIG. 4 is a schematic structural diagram of a first embodiment of a network-side device according to the present invention, where the network-side device may specifically be a network device having a communication function, such as a base station and a radio network controller. As shown in FIG. 4, the network-side device 40 in this embodiment may include: an acquiring module 41 and a sending module 42.

The acquiring module 41 is configured to acquire a resource scheduling manner of a first base station, where the resource scheduling manner is a manner of allocating, by the first base station, resources for downlink service data transmission of a local user equipment; and

the sending module 42 is configured to send a notification message including the resource scheduling manner to a user equipment in a second base station, so that the user equipment in the second base station detects, according to the resource scheduling manner, an interference signal generated by the first base station and performs interference cancellation processing according to a detection result;

where a cell in which the user equipment is located in the second base station uses the second base station as a serving base station, and the first base station is a serving base station of a neighboring cell of the user equipment in the second base station.

The network-side device in this embodiment may be used to execute the technical solution of the method embodiment shown in FIG. 2. The implementation principles and technical effects are similar, and are not further described herein.

Optionally, the network-side device is the first base station, and the acquiring module 41 is specifically configured to:

generate the resource scheduling manner; or

receive a notification message that is sent by the radio network controller and includes the resource scheduling manner.

Optionally, the sending module 42 is specifically configured to:

send the notification message including the resource scheduling manner to the user equipment in the second base station by using physical layer signaling or a system broadcast message.

Optionally, the network-side device is a radio network controller, and the acquiring module 41 is specifically configured to:

generate the resource scheduling manner; or

receive a notification message that is sent by the first base station and includes the resource scheduling manner.

Optionally, the sending module 42 is specifically configured to:

send the notification message including the resource scheduling manner to the user equipment in the second base station by using RRC signaling.

Optionally, the network-side device is the second base station, and the acquiring module 41 is specifically configured to:

receive a notification message that is sent by the radio network controller and includes the resource scheduling manner.

Optionally, the sending module 42 is specifically configured to:

send the notification message including the resource scheduling manner to the user equipment in the second base station by using physical layer signaling or a system broadcast message.

Optionally, the resource scheduling manner includes any piece of the following information or a combination thereof:

a modulation manner;

code channel information;

a spreading factor; and

a resource allocation rule.

Optionally, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

The network-side device in this embodiment may be used to execute the technical solution of the foregoing method embodiment. The implementation principles and technical effects are similar, and are not further described herein.

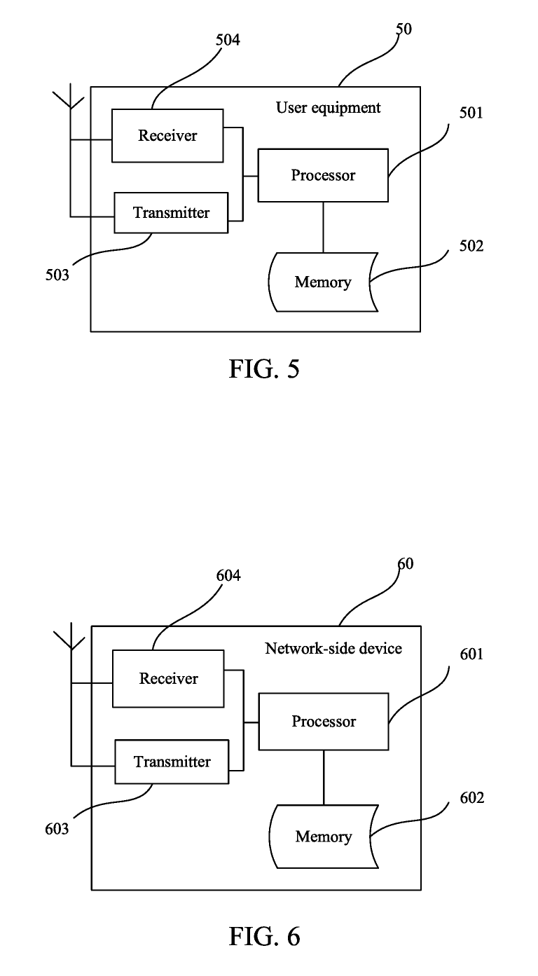

FIG. 5 is a schematic structural diagram of a second embodiment of a user equipment according to the present invention, where the user equipment provided by this embodiment may be various terminals having a communication function. As shown in FIG. 5, the user equipment 50 in this embodiment may include a processor 501 and a memory 502. The user equipment 50 may further include a transmitter 503 and a receiver 504. The transmitter 503 and receiver 504 may be connected to the processor 501. The memory 502 stores an execution command; when the user equipment 50 runs, the processor 501 communicates with the memory 502; the processor 501 calls the execution command in the memory 502 to execute the following operations:

receiving, by the user equipment, a notification message sent by a network side, where the notification message includes a resource scheduling manner of a first base station, and the resource scheduling manner is a manner of allocating, by the first base station, resources for downlink service data transmission of a local user equipment; and

detecting, by the user equipment according to the resource scheduling manner, an interference signal generated by the first base station, and performing interference cancellation processing according to a detection result;

where a cell in which the user equipment is located uses a second base station as a serving base station, and the first base station is a serving base station of a neighboring cell of the user equipment.

Optionally, the receiving, by the user equipment, a notification message sent by a network side includes:

receiving, by the user equipment, a notification message sent by the first base station by using physical layer signaling or a system broadcast message; or

receiving, by the user equipment, a notification message sent by the second base station by using physical layer signaling or a system broadcast message; or

receiving, by the user equipment, a notification message sent by a radio network controller by using RRC signaling.

Optionally, the detecting, by the user equipment according to the resource scheduling manner, an interference signal generated by the first base station includes:

acquiring, by the user equipment, a modulation manner or code channel information or a combination thereof according to the resource scheduling manner; and

detecting, by the user equipment according to the modulation manner or the code channel information or the combination thereof, the interference signal generated by the first base station, and obtaining interference information of the interference signal.

Optionally, the resource scheduling manner includes any piece of the following information or a combination thereof:

the modulation manner;

the code channel information;

a spreading factor; and

a resource allocation rule.

Optionally, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

Optionally, the detecting, according to the resource scheduling manner, an interference signal generated by the first base station includes:

if the user equipment determines, according to the resource scheduling manner, that multiple code channels are continuous, performing, by the user equipment, joint detection for the multiple continuous code channels.

Optionally, before the performing, by the user equipment, joint detection for the multiple continuous code channels, the operation further includes:

determining, by the user equipment, that the multiple continuous code channels use a same modulation manner; and

the performing, by the user equipment, joint detection for the multiple continuous code channels includes:

performing, by the user equipment, joint detection of the modulation manner for the multiple continuous code channels that use the same modulation manner.

Optionally, before the performing, by the user equipment, joint detection for the multiple continuous code channels, the operation further includes:

determining, by the user equipment, that the multiple continuous code channels use same code channel power; and

the performing, by the user equipment, joint detection for the multiple continuous code channels includes:

performing, by the user equipment, joint detection of the code channel power for the multiple continuous code channels that use the same code channel power.

The user equipment in this embodiment may be used to execute the technical solution of the foregoing method embodiment. The implementation principles and technical effects are similar, and are not further described herein.

FIG. 6 is a schematic structural diagram of a second embodiment of a network-side device according to the present invention. The network-side device specifically may be a network device having a communication function, such as a base station and a radio network controller. As shown in FIG. 6, the network-side device 60 in this embodiment may include: a processor 601 and a memory 602. The network-side device 60 may further include a transmitter 603 and a receiver 604. The transmitter 603 and receiver 604 may be connected to the processor 601. Those skilled in the art may understand that the network-side device does not include an antenna when it is a radio network controller. The memory 602 stores an execution commands; when the network-side device 60 runs, the processor 601 communicates with the memory 602; the processor 601 calls the execution command in the memory 602 to execute the following operations:

acquiring, by a network-side device, a resource scheduling manner of a first base station, where the resource scheduling manner is a manner of allocating, by the first base station, resources for downlink service data transmission of a local user equipment; and

sending, by the network-side device, a notification message including the resource scheduling manner to a user equipment in a second base station, so that the user equipment in the second base station detects, according to the resource scheduling manner, an interference signal generated by the first base station and performs interference cancellation processing according to a detection result;

where a cell in which the user equipment is located in the second base station uses the second base station as a serving base station, and the first base station is a serving base station of a neighboring cell of the user equipment in the second base station.

Optionally, the network-side device is the first base station, and the acquiring, by a network-side device, a resource scheduling manner of a first base station includes:

generating, by the first base station, the resource scheduling manner; or

receiving, by the first base station, a notification message that is sent by the radio network controller and includes the resource scheduling manner.

Optionally, the sending, by the network-side device, a notification message including the resource scheduling manner to a user equipment in a second base station includes:

sending, by the first base station, the notification message including the resource scheduling manner to the user equipment in the second base station by using physical layer signaling or a system broadcast message.

Optionally, the network-side device is a radio network controller, and the acquiring, by a network-side device, a resource scheduling manner of a first base station includes:

generating, by the radio network controller, the resource scheduling manner; or

receiving, by the radio network controller, a notification message that is sent by the first base station and includes the resource scheduling manner.

Optionally, the sending, by the network-side device, a notification message including the resource scheduling manner to a user equipment in a second base station includes:

sending, by the radio network controller, the notification message including the resource scheduling manner to the user equipment in the second base station by using RRC signaling.

Optionally, the network-side device is the second base station, and the acquiring, by a network-side device, a resource scheduling manner of a first base station includes:

receiving, by the second base station, a notification message that is sent by the radio network controller and includes the resource scheduling manner.

Optionally, the sending, by the network-side device, a notification message including the resource scheduling manner to a user equipment in a second base station includes:

sending, by the second base station, the notification message including the resource scheduling manner to the user equipment in the second base station by using physical layer signaling or a system broadcast message.

Optionally, the resource scheduling manner includes any piece of the following information or a combination thereof:

a modulation manner;

code channel information;

a spreading factor; and

a resource allocation rule.

Optionally, the resource allocation rule is as follows: in a TTI, one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or

the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or

the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or

the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or

the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

The network-side device in this embodiment may be used to execute the technical solution of the foregoing method embodiment. The implementation principles and technical effects are similar, and are not further described herein.

In the several embodiments provided in the present application, it should be understood that the disclosed device and method may be implemented in other manners. For example, the described device embodiment is merely exemplary. For example, the unit division or the module division is merely logical function division and may be other division in practical implementation. For example, a plurality of units or modules may be combined or integrated into another system, or some features may be ignored or not performed. In addition, the shown or discussed mutual couplings or direct couplings or communication connections may be implemented via some interfaces. The indirect couplings or communication connections between the apparatuses or units may be implemented in electronic, mechanical, or other forms.

Modules described as separate components may be or may not be physically separated. Components shown as modules may be or may not be physical modules, that is, may be integrated or distributed to a plurality of network units. A part or all of the modules may be selected according to actual needs to achieve the objectives of the solutions of the embodiments.

Persons of ordinary skill in the art may understand that all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium includes various media capable of storing program codes, such as a ROM, a RAM, a magnetic disk, or an optical disk.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some or all the technical features thereof, without departing from the scope of the technical solutions of the embodiments of the present invention.

1-22. (canceled)

23. An interference processing method, comprising:
receiving, by a user equipment, a notification message sent by a network side, wherein the notification message comprises a resource scheduling manner of a first base station and wherein the resource scheduling manner is a manner of allocating, by the first base station, resources for downlink service data transmission of a local user equipment; and
detecting, by the user equipment according to the resource scheduling manner, an interference signal generated by the first base station; and
performing interference cancellation processing according to a detection result;
wherein a cell in which the user equipment is located uses a second base station as a serving base station; and
wherein the first base station is a serving base station of a neighboring cell of the user equipment.

24. The method according to claim 23, wherein receiving the notification message sent by a network side comprises:
receiving, by the user equipment, a notification message sent by the first base station by using physical layer signaling or a system broadcast message; or
receiving, by the user equipment, a notification message sent by the second base station by using physical layer signaling or a system broadcast message; or
receiving, by the user equipment, a notification message sent by a radio network controller by using radio resource control (RRC) signaling.

25. The method according to claim 24, wherein detecting the interference signal generated by the first base station comprises:
acquiring, by the user equipment, a modulation manner or code channel information or a combination thereof according to the resource scheduling manner; and
detecting, by the user equipment according to the modulation manner or the code channel information or the combination thereof, the interference signal generated by the first base station, and obtaining interference information of the interference signal.

26. The method according to claim 25, wherein the resource scheduling manner comprises any piece of the following information or a combination thereof:
the modulation manner;
the code channel information;
a spreading factor; and
a resource allocation rule.

27. The method according to claim 26, wherein the resource allocation rule is as follows: in a transmission time interval (TTI), one modulation manner is restricted to be available, and if at least one user equipment in the first base station uses the restricted modulation manner, the first base station sequentially allocates a code channel to the at least one user equipment in the first base station according to a preset sequence value of the code channel and based on a first preset sequence; or
the resource allocation rule is as follows: in a TTI, two modulation manners are restricted to be available, and if at least two user equipments in the first base station use the two restricted modulation manners, the first base station, according to orders of the modulation manners and preset sequence values of code channels, sequentially allocates a code channel to a user equipment of a high order modulation manner in the first base station based on a second preset sequence, and sequentially allocates a code channel to a user equipment of a low order modulation manner in the first base station based on a third preset sequence; or
the resource allocation rule is as follows: in a TTI, one modulation manner is restricted to be available, and if at least two user equipments in the first base station use the restricted modulation manner and code channel power required for downlink service transmission of the at least two user equipments in the first base station is different, the first base station, according to the code channel power and preset sequence values of code channels, sequentially allocates a code channel to a user equipment meeting first code channel power in the first base station based on a fourth preset sequence, and sequentially allocates a code channel to a user equipment meeting second code channel power in the first base station based on a fifth preset sequence, wherein the first code channel power is higher than the second code channel power; or
the resource allocation rule is as follows: in a TTI, one modulation manner is restricted to be available, and if at least one user equipment in the first base station uses the restricted modulation manner, the first base station sequentially allocates a code channel among first preset code channels to the at least one user equipment in the first base station according to a first preset spreading factor and based on a sixth preset sequence; or
the resource allocation rule is as follows: in a TTI, one modulation manner is restricted to be available, and if at least one user equipment in the first base station uses the restricted modulation manner and the first base station determines, according to a status parameter of the at least one user equipment, that the at least one user equipment in the first base station is an interfering user equipment, the first base station sequentially allocates a code channel among second preset code channels to the at least one user equipment in the first base station according to a second preset spreading factor and based on a seventh preset sequence.

28. An interference processing method, comprising:
acquiring, by a network-side device, a resource scheduling manner of a first base station, wherein the resource scheduling manner is a manner of allocating, by the first base station, resources for downlink service data transmission of a local user equipment; and
sending, by the network-side device, a notification message comprising the resource scheduling manner to a user equipment in a second base station, so that the user equipment in the second base station detects, according to the resource scheduling manner, an interference signal generated by the first base station and performs interference cancellation processing according to a detection result;
wherein a cell in which the user equipment is located in the second base station uses the second base station as a serving base station; and
wherein the first base station is a serving base station of a neighboring cell of the user equipment in the second base station.

29. The method according to claim 28, wherein the network-side device is the first base station and wherein acquiring the resource scheduling manner of a first base station comprises:
generating, by the first base station, the resource scheduling manner; or
receiving, by the first base station, a notification message that is sent by a radio network controller and comprises the resource scheduling manner.

30. The method according to claim 29, wherein sending the notification message comprising the resource scheduling manner to a user equipment in a second base station comprises sending, by the first base station, the notification message comprising the resource scheduling manner to the user equipment in the second base station by using physical layer signaling or a system broadcast message.

31. The method according to claim 28, wherein the network-side device is a radio network controller and wherein acquiring the resource scheduling manner of a first base station comprises:
generating, by the radio network controller, the resource scheduling manner; or
receiving, by the radio network controller, a notification message that is sent by the first base station and comprises the resource scheduling manner.

32. The method according to claim 31, wherein sending the notification message comprising the resource scheduling manner to a user equipment in a second base station comprises sending, by the radio network controller, the notification message comprising the resource scheduling manner to the user equipment in the second base station by using RRC signaling.

33. The method according to claim 28, wherein the network-side device is the second base station and wherein acquiring the resource scheduling manner of a first base station comprises receiving, by the second base station, a notification message that is sent by a radio network controller and comprises the resource scheduling manner.

34. The method according to claim 33, wherein sending the notification message comprising the resource scheduling manner to a user equipment in a second base station comprises sending, by the second base station, the notification message comprising the resource scheduling manner to the user equipment in the second base station by using physical layer signaling or a system broadcast message.

35. A user equipment, comprising:
a receiving module, configured to receive a notification message sent by a network side, wherein the notification message comprises a resource scheduling manner of a first base station and the resource scheduling manner is a manner of allocating, by the first base station, resources for downlink service data transmission of a local user equipment; and
a processing module, configured to detect, according to the resource scheduling manner, an interference signal generated by the first base station and to perform interference cancellation processing according to a detection result;
wherein a cell in which the user equipment is located uses a second base station as a serving base station; and
wherein the first base station is a serving base station of a neighboring cell of the user equipment.

36. The user equipment according to claim 35, wherein the receiving module is specifically configured to:
receive a notification message sent by the first base station by using physical layer signaling or a system broadcast message; or
receive a notification message sent by the second base station by using physical layer signaling or a system broadcast message; or
receive a notification message sent by a radio network controller by using RRC signaling.

37. The user equipment according to claim 36, wherein the processing module is configured to:
acquire a modulation manner or code channel information or a combination thereof according to the resource scheduling manner; and
detect, according to the modulation manner or the code channel information or the combination thereof, the interference signal generated by the first base station; and
obtain interference information of the interference signal.

38. A network-side device, comprising:
an acquiring module, configured to acquire a resource scheduling manner of a first base station, wherein the resource scheduling manner is a manner of allocating, by the first base station, resources for downlink service data transmission of a local user equipment; and
a sending module, configured to send a notification message comprising the resource scheduling manner to a user equipment in a second base station, so that the user equipment in the second base station detects, according to the resource scheduling manner, an interference signal generated by the first base station and performs interference cancellation processing according to a detection result;
wherein a cell in which the user equipment is located in the second base station uses the second base station as a serving base station; and
wherein the first base station is a serving base station of a neighboring cell of the user equipment in the second base station.

39. The network-side device according to claim 38, wherein the network-side device is the first base station and wherein the acquiring module is configured to:
generate the resource scheduling manner; or
receive a notification message that is sent by a radio network controller and comprises the resource scheduling manner.

40. The network-side device according to claim 39, wherein the sending module is configured to send the notification message comprising the resource scheduling manner to the user equipment in the second base station by using physical layer signaling or a system broadcast message.

41. The network-side device according to claim 38, wherein the network-side device is a radio network controller and wherein the acquiring module is configured to:
generate the resource scheduling manner; or
receive a notification message that is sent by the first base station and comprises the resource scheduling manner.

42. The network-side device according to claim 41, wherein the sending module is configured to send the notification message comprising the resource scheduling manner to the user equipment in the second base station by using RRC signaling.

43. The network-side device according to claim 38, wherein the network-side device is the second base station and wherein the acquiring module is configured to receive a notification message that is sent by a radio network controller and comprises the resource scheduling manner.

44. The network-side device according to claim 43, wherein the sending module is configured to send the notification message comprising the resource scheduling manner to the user equipment in the second base station by using physical layer signaling or a system broadcast message.
